(19) United States
(12) Patent Application Publication
(10) Pub. No.: US 2021/0325216 A1
(43) Pub. Date: Oct. 21, 2021

(54) ULTRASONIC FLOW METER

(71) Applicant: Spire Metering Technology LLC, Marlborough, MA (US)

(72) Inventor: Chang Shen, Belmont, MA (US)

(21) Appl. No.: 17/232,270

(22) Filed: Apr. 16, 2021

Related U.S. Application Data
(60) Provisional application No. 63/011,349, filed on Apr. 17, 2020.

(51) Int. Cl. G01F 1/66; G01F 15/02

(52) U.S. Cl. CPC G01F 1/662; G01F 1/667; G01F 15/022

(57) ABSTRACT

A flow meter includes a hollow, two-piece, flow tube that is shaped to define an internal passageway through which a fluid travels. A pair of transducers, a set of reflectors, and a temperature sensor are mounted in the flow tube in fluid communication with the internal passageway, the reflectors being arranged to reflect a sound wave transmitted between the pair of transducers along a W-shaped travel path. The transducers and a center reflector are mounted in the top wall of the flow tube and lie within a common plane which is spaced substantially in from the interior surface of the flow tube. A cavity is formed in the interior surface of the top wall between the center reflector and each transducer, with each cavity situated outside of the designed travel path. In use, air bubbles present in the fluid collect within the cavities, thereby ensuring flow meter measurement accuracy.

### CROSS-REFERENCE TO RELATED APPLICATIONS

The present application claims the benefit under 35 U.S.C. 119(e) to U.S. Provisional Patent Application No. 63/011,349, which was filed on Apr. 17, 2020 in the name of Chang Shen, the disclosure of which is incorporated herein by reference.

### FIELD OF THE INVENTION

The present invention relates generally to fluid measurement devices and, more particularly, ultrasonic flow meters.

### BACKGROUND OF THE INVENTION

A flow meter is a fluid measurement device that measures the velocity of fluid traveling through a designated flow tube, or conduit, in order to calculate total volume flow. In this manner, a flow meter can determine the total volume of fluid used in a particular environment. For this reason, flow meters are commonly utilized in both public and private water systems to measure water consumption over a period of time.

An ultrasonic flow meter is one type of flow meter that relies upon the transmission and measurement of ultrasonic waves within the designated conduit in order accurately calculate fluid flow rate and/or volume. Specifically, one of a pair of ultrasonic transducers transmits ultrasonic sound waves through fluid traveling within the flow tube. In turn, the ultrasonic waves are redirected within the flow tube by a series of fixed reflectors. Ultimately, the ultrasonic sound waves are received by the other of the pair of ultrasonic transducers. The rate of wave propagation between the pair of fixed transducers, or sensors, is then utilized by a processor to calculate fluid flow rate and/or volume.

It has been found that the particular arrangement of transducers and reflectors within the flow tube, or piping, directly affects the accuracy of the fluid flow rate and volume calculations. Examples of flow meters with various transducer and sensor configurations are shown in, inter alia, U.S. Pat. No. 9,714,855 to O. Bar-on, U.S. Pat. No. 9,182,260 to S. T. Nielsen et al., U.S. Pat. No. 8,904,881 to H. Sonnenberg et al., and European Patent No. 0708313 to P. Greppmaier, all of the aforementioned disclosures being incorporated herein by reference.

In one type of flow meter which is well known in the art, transducers and reflectors are arranged such that ultrasonic sound waves propagate in a generally W-shaped travel path. Specifically, the flow meter is constructed with a pair of spaced-apart transducers mounted in a first surface (e.g., top) of the flow tube at the same angle of orientation. A pair of reflectors is mounted in the opposite surface (e.g., bottom) of the pair of transducers, with one reflector in direct vertical alignment with each transducer. A third reflector is mounted in the first surface of the flow tube at the approximate midpoint between the pair of transducers. As a result, an ultrasonic sound wave propagated from a first transducer is redirected between the three separate reflectors along a generally W-shaped travel path before being received by the second transducer.

Although well known in the art, ultrasonic flow meters of the type as described above have been found to suffer from a number of notable shortcomings. In particular, the presence of air bubbles in the fluid can compromise the accuracy of fluid flow measurements. Specifically, the top surface of the flow tube in conventional ultrasonic flow meters often has stepped-shaped protrusions (e.g., due to the profile and location of transducers and reflectors). Furthermore, these inward protrusions in the top surface of the flow tube are often located in front of the pair of spaced-apart transducers, as shown in U.S. Pat. No. 8,904,881 to H. Sonnenberg et al. As can be appreciated, these protrusions create cavities which attract air bubbles that can negatively affect the rate of propagation of ultrasonic waves along the desired travel path, thereby compromising the overall effectiveness of fluid flow rate calculations. In particular, the presence of cavities located beneath the transducers increases the likelihood that air bubbles will accumulate directly within the designated sound wave travel path and thereby affect sound wave propagation and overall measurement accuracy.

### SUMMARY OF THE INVENTION

In view thereof, it is an object of the present invention to provide a novel ultrasonic flow meter.

It is another object of the present invention to provide an ultrasonic flow meter that measures the velocity of fluid traveling through a flow tube in order to calculate total volume flow.

It is yet another object of the present invention to provide an ultrasonic flow meter of the type as described above which utilizes a pair of ultrasonic transducers to transmit ultrasonic sound waves through fluid traveling within the flow tube.

It is still another object of the present invention to provide an ultrasonic flow meter of the type as described above which includes a series of fixed reflectors to redirect the ultrasonic sound waves between the pair of ultrasonic transducers along an optimal travel path.

It is yet still another object of the present invention to provide an ultrasonic flow meter of the type as described above which is designed to minimize the effect of air bubbles present within the flow tube when measuring fluid flow rates in order to ensure accuracy.

It is another object of the present invention to provide an ultrasonic flow meter of the type as described above which is inexpensive to manufacture, easy to assemble, and simple to use.

Accordingly, as one feature of the present invention, there is provided a flow meter for measuring fluid flow rates, the flow meter comprising (a) a hollow flow tube shaped to define an internal passageway, the flow tube comprising a top wall, a bottom wall, an interior surface, an exterior surface, a fluid input end, and a fluid output end, (b) a set of transducers mounted in the top wall of the flow tube in fluid communication with the internal passageway, each of the set of transducers having a distal end, and (c) a set of reflectors mounted in the flow tube in fluid communication with the internal passageway, the set of reflectors redirecting a sound wave transmitted from one of the set of transducers to the other of the set of transducers along a designated travel path, the set of reflectors comprising a center reflector mounted in the top wall of the flow tube, (d) wherein the distal end of each of the set of transducers and the center reflector lie in a common plane which is spaced substantially in from the interior surface of the flow tube.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is an exploded perspective view of selected components of an ultrasonic flow meter constructed according to the teachings of the present invention;

FIG. 2 is an assembled, longitudinal section view of the selected components of the ultrasonic flow meter shown in FIG. 1;

FIG. 3 is a front perspective view of the selected components of the ultrasonic flow meter shown in FIG. 2;

FIG. 4 is a simplified longitudinal section view of the selected components of the ultrasonic flow meter shown in FIG. 2 which is useful in understanding the propagation path of ultrasonic sound waves between transducers; and

FIG. 5 is a front perspective, longitudinal section view of selected components of the ultrasonic flow meter of the present invention which is useful in understanding the ease of assembly of the flow meter with water-tight capabilities.

### DETAILED DESCRIPTION OF THE INVENTION

### Ultrasonic Flow Meter 11

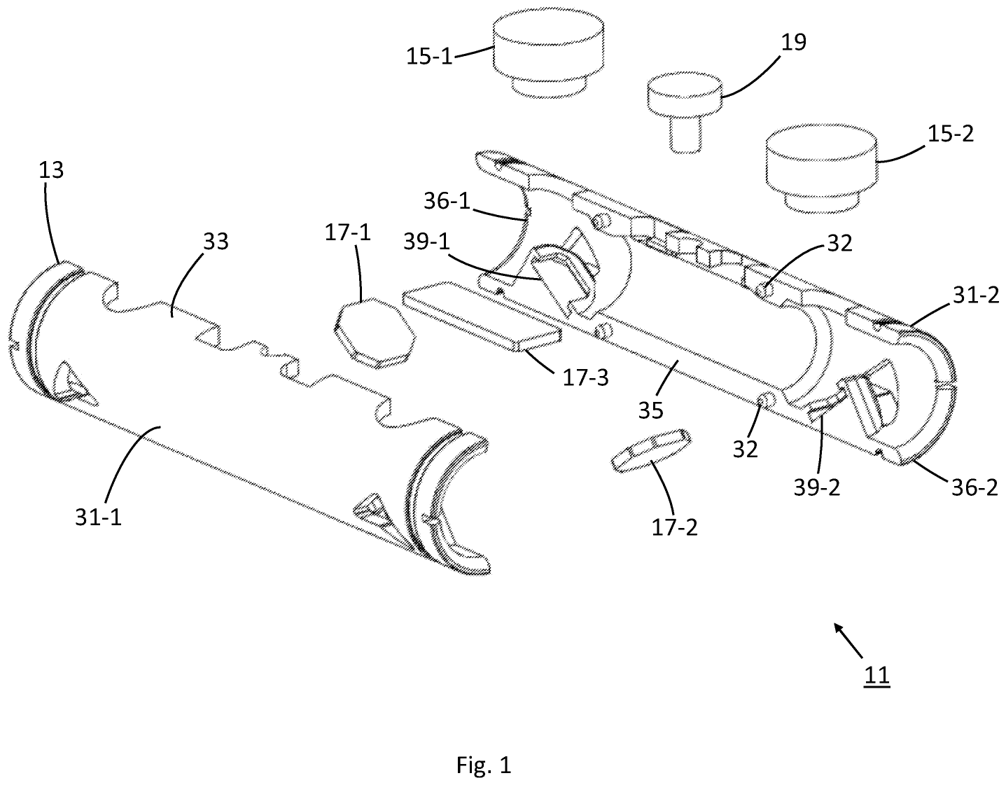

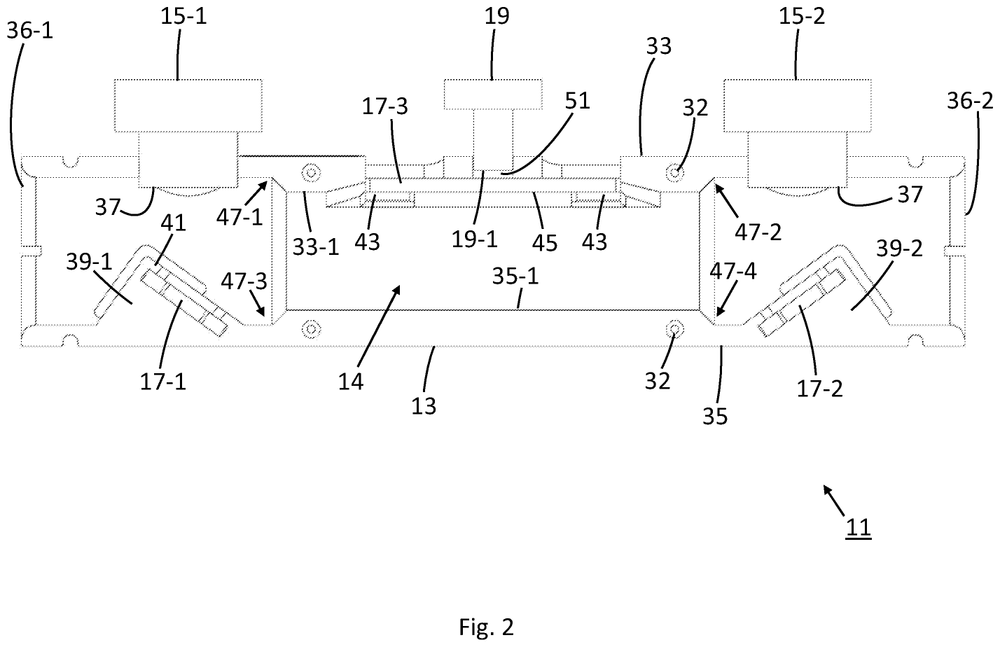

Referring now to FIGS. 1 and 2, there is shown selected components of an ultrasonic flow meter constructed according to the teachings of the present invention, the flow meter being identified generally by reference numeral 11. As will be explained further below, flow meter 11 is uniquely designed to calculate fluid flow rate with a high degree of accuracy. Additionally, the construction of flow meter 11 allows for ease of assembly, thereby reducing overall manufacturing costs.

In the description that follows, ultrasonic flow meter 11 is described primarily in connection with the measurement of the flow rate and/or volume of water delivered therethrough. However, it is to be understood that flow meter 11 is not limited for use with water, but rather could be utilized with other types of fluids without departing from the spirit of the present invention.

Ultrasonic flow meter 11 comprises a two-piece, hollow flow tube 13 which defines a substantially enclosed, internal passageway 14 through which water travels. Additionally, flow meter 11 comprises (i) a pair of ultrasonic transducers 15-1 and 15-2, which are designed to transmit and receive ultrasonic sound waves through water traveling within passageway 14, (ii) a set of reflectors 17-1 thru 17-3 mounted within flow tube 13 that together redirect ultrasonic sound waves transmitted between transducers 15 along a generally W-shaped travel path, and (iii) a temperature sensor 19 mounted on flow tube 13 that is designed to measure the temperature of water within passageway 14 in order to improve the accuracy of flow rate calculations.

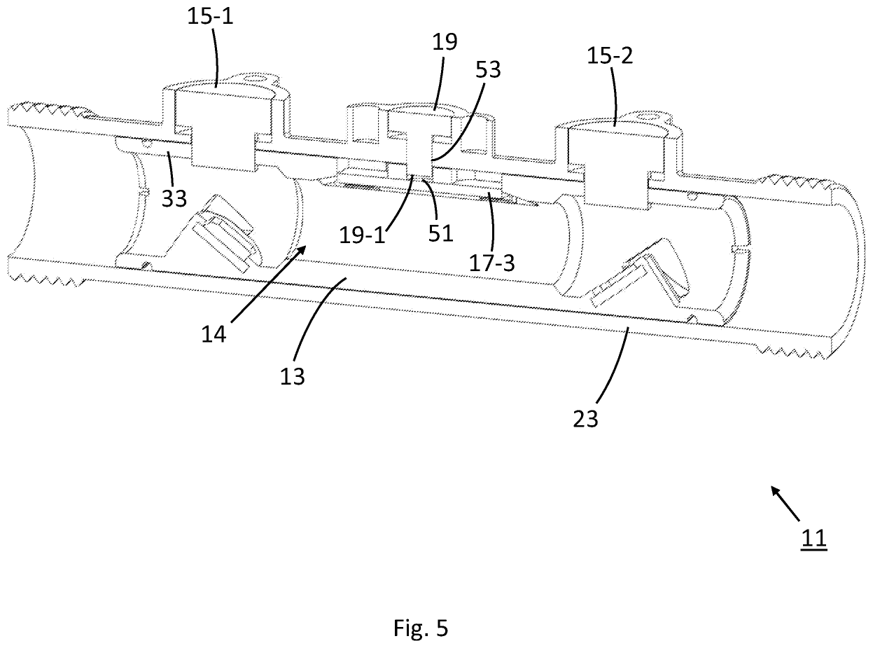

Although not shown in FIGS. 1 and 2, flow meter 11 additionally includes (i) a flow cell 23, shown in FIG. 5, which is coaxially mounted over flow tube 13 in order to facilitate the water-tight assembly of flow meter 11, (ii) electronics (not shown) in electronic communication with transducers 15 and sensor 19 (e.g. via associated conductive wiring) to process sensor readings as part of the designated flow rate calculations, and (iii) an electronics housing, or enclosure, (not shown) mounted to flow cell 23 and designed to enclose the flow meter electronics. Aspects of flow meter 11 that are not directed to its novel features are not shown in detail herein for ease of illustration.

As seen most clearly in FIG. 1, flow tube 13 comprises left and right-side pieces 31-1 and 31-2 that preferably assemble together using complementary sets of press-fit posts 32 and bores (not shown). Together, pieces 31 form a generally cylindrical tube with a top wall 33, a bottom wall 35, a fluid input end 36-1 and a fluid output end 36-2.

Referring now to FIG. 2, transducers 15 project partially through complementary bores formed in top wall 33 of flow tube 13, the distal end 37 of transducers 15 lying within the same plane for reasons to become apparent below. As can be appreciated, transducers 15 are spaced apart the majority of the length of flow tube 13 in order to suitably capture flow rate measurements (i.e., by enabling the sound waves enough travel time within the water to accurately calculate fluid flow rates).

As referenced previously, reflectors, or mirrors, 17 are mounted on flow tube 13 within passageway 14 and together redirect ultrasonic sound waves transmitted between transducers 15 along a generally W-shaped travel path. Specifically, lower reflectors 17-1 and 17-2 are mounted on angled platforms 39-1 and 39-2, respectively, which are integrally formed on bottom wall 35, each platform 39 including an integral flange 41 along its periphery for retaining its associated reflector 17. In this manner, each reflector 17 can be easily mounted in place on a platform 39 on right-side piece 31-1 through insertion into the internal slot defined by its corresponding flange 41, thereby simplifying assembly. As can be seen, reflectors 17-1 and 17-2 are disposed in direct vertical alignment with transducers 15-1 and 15-2, respectively.

It should be noted that a considerable portion of reflectors 17-1 and 17-2 is disposed beneath the interior surface 35-1 of bottom wall 35. As can be appreciated, the lowering, or depression, of reflectors 17-1 and 17-2 beneath interior surface 35-1 serves to minimize the extent of fluid flow obstruction.

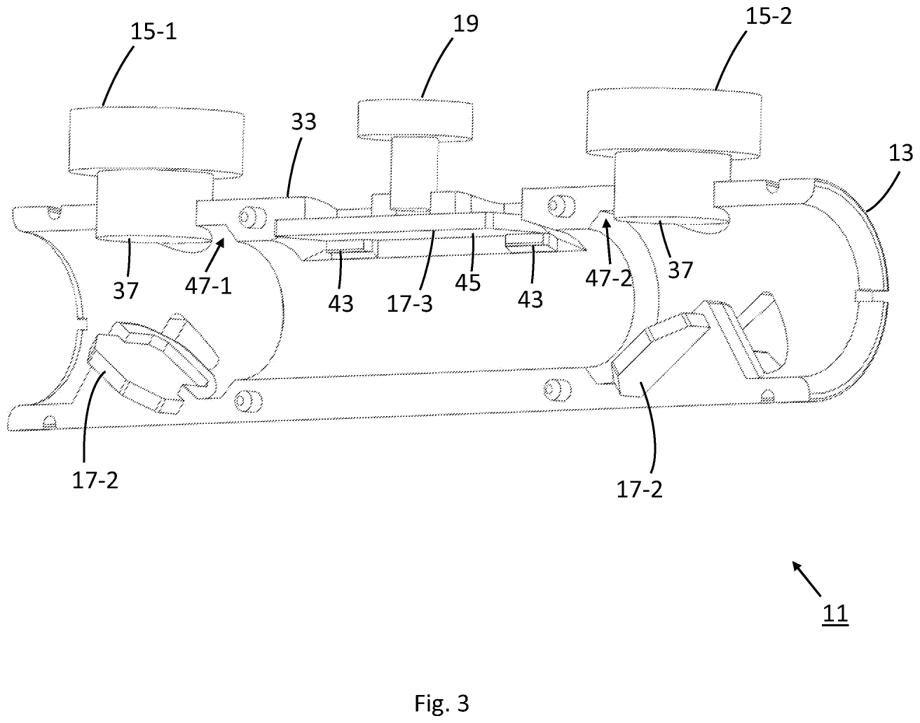

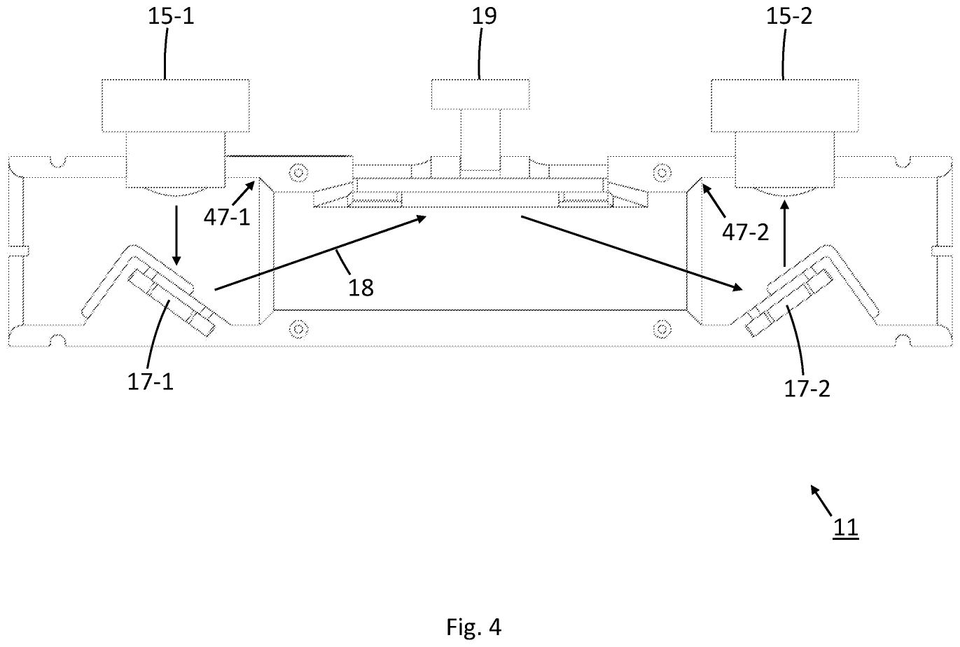

An elongated middle reflector 17-3 is mounted in top wall 33 at the approximate midpoint between transducers 15, reflector 17-3 being retained in place by a pair of detents, or tabs, 43 which are integrally formed in flow tube 13, as seen most clearly in FIG. 3. Middle reflector 17-3 is preferably of a length that is suitable to ensure redirection of the complete sound wave transmitted between transducers 15. Together, reflectors 17 redirect ultrasonic sound waves transmitted between transducers 15 along a generally W-shaped travel path 18, as shown in FIG. 4. As can be appreciated, the propagation of sound waves along a W-shaped travel path optimizes the accuracy of flow rate calculations.

Referring back to FIGS. 2 and 3, the exposed bottom surface 45 of reflector 17-3 lies in a coplanar relationship relative to the distal end 37 of transducers 15. Additionally, a pair of recesses, or cavities, 47-1 and 47-2 is formed in top wall 33 between reflector 17-3 and transducers 15, wherein each recess 47 lies substantially above the common plane defined by reflector 17-3 and transducers 15. As a result, any air bubbles present in the water, which would otherwise compromise the accuracy of flow rate calculations, are naturally drawn upward into cavities 47 and thereby out of designated sound wave travel path 18, which is highly desirable. It should also be noted that the special shape of recesses 47 also serves to block background noise (e.g., stray and reverberation sound) from entering into the center portion of flow tube 13 where the principal ultrasonic wave measurements are collected. For this reason, additional recesses 47-3 and 47-4 are preferably provided in bottom wall 35 in vertical alignment with recesses 47-1 and 47-2, respectively.

As seen most clearly in FIG. 5, temperature sensor 19 fittingly protrudes through axially aligned bores formed in flow tube 13 and flow cell 23. Distal end 19-1 of temperature sensor 19 is disposed directly behind middle, or top, reflector 17-3 in a spaced apart relationship relative thereto. Due to the non-watertight mounting of reflector 17-3 on top wall 33 of flow tube 13, a narrow fluid channel 51 is formed between reflector 17-3 and distal end 19-1, as seen most clearly in FIGS. 2 and 5. A watertight sealant 53 is preferably disposed between temperature sensor 19 and flow cell 23 to prevent any leaking of fluid outside flow meter 11.

Accordingly, any water flowing within central passageway 14 is designed to circulate through channel 51 and into direct contact with temperature sensor 19. This direct contact established between sensor 19 and the water flowing through passageway 14 improves the accuracy of temperature measurements, thereby improving the overall precision of flow meter 11.

As seen in FIG. 5, flow cell 23 is coaxially mounted over flow tube 13 and serves, inter alia, to assist in the retention of transducers 15 and temperature sensor 19. In turn, an electronics enclosure (not shown), which houses the processor for performing the flow rate calculations, is mounted over flow cell 23 to seal transducers 15 and sensor 19. To facilitate assembly and ensure an adequate watertight seal, a continuous peripheral sealant ring (not shown) is preferably applied along the top, peripheral edge of flow cell 23. Therefore, by simply mounting the electronics enclosure over flow cell 23, transducers 15, sensor 19 and, in particular, internal passageway 14 are effectively sealed.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

### Principal Features and Advantages of the Present Invention

As referenced above, flow meter 11 is constructed with a number of notable design features which provide significant performance advantages over traditional flow meters.

As a first design feature, bottom surface 45 of middle reflector 17-3 and distal ends 37 of transducers 15 are disposed in a coplanar arrangement. Applicant has recognized that the presence of non-uniform surfaces (e.g. cavities) within the top surface of a flow tube can attract air bubbles. As such, flow meter 11 is specifically designed with an internal profile that minimizes the presence of cavities within the sound wave travel path to the greatest extent possible.

In fact, as a second design feature, a small set of cavities 47 is intentionally incorporated into top surface 33 of flow tube 13 above the coplanar surface defined by transducers 15 and middle reflector 17-3. In this manner, air bubbles accumulating within such cavities remain completely outside of the designated wave travel path 18 and do not compromise the accuracy of flow rate measurements.

As a third design feature, temperature sensor 19 is positioned directly above top reflector 17-3. Additionally, flow tube 13 is configured such that fluid is adapted to travel within a narrow channel 51 located between top reflector 17-3 and temperature sensor 19. Through direct contact with the fluid, temperature sensor 19 is adapted to measure the fluid temperature more accurately, with the accumulated temperature readings utilized by the processor to calculate fluid flow rates more reliably. Additionally, the location of temperature sensor 19 directly above middle reflector 17-3 allows for a more compact assembly, with the electronics connected to both transducers 15 and temperature sensor 19 being centrally located in its designated housing in close proximity thereto.

As a fourth design feature, a continuous ring of sealant (not shown) is preferably applied along the periphery of flow cell 23. Therefore, by simply mounting an electronics enclosure (not shown) over flow cell 23, the transducers 15, sensor 19 and, in particular, internal passageway 14 are effectively sealed. Consequently, the overall manufacturing process is significantly simplified.

As a fifth design feature, at least a portion of the internal surface of bottom wall 35 is roughened between reflectors 17-1 and 17-2. As can be appreciated, the roughening of this internal surface serves to absorb multi-mode waves and reverberation noise, which can be generated due to the considerable length of top reflector 17-3. The absorption of these negative artifacts improves the overall signal-to-noise ratio, thereby improving measurement accuracy.

What is claimed is:

1. A flow meter for measuring fluid flow rates, the flow meter comprising:
(a) a hollow flow tube shaped to define an internal passageway, the flow tube comprising a top wall, a bottom wall, an interior surface, an exterior surface, a fluid input end, and a fluid output end;
(b) a set of transducers mounted in the top wall of the flow tube in fluid communication with the internal passageway, each of the set of transducers having a distal end; and
(c) a set of reflectors mounted in the flow tube in fluid communication with the internal passageway, the set of reflectors redirecting a sound wave transmitted from one of the set of transducers to the other of the set of transducers along a designated travel path, the set of reflectors comprising a center reflector mounted in the top wall of the flow tube;
(d) wherein the distal end of each of the set of transducers and the center reflector are spaced substantially in from the interior surface of the flow tube.

2. The flow meter as claimed in claim 1 wherein a first pair of cavities is formed in the interior surface of the top wall.

3. The flow meter as claimed in claim 2 wherein one of the first pair of cavities is located between the center reflector and each of the set of transducers.

4. The flow meter as claimed in claim 3 wherein the distal end of each of the set of transducers and the center reflector extend substantially beyond the first pair of cavities.

5. The flow meter as claimed in claim 4 wherein the distal end of each of the set of transducers and the center reflector lie in a common plane which is spaced substantially in from the interior surface of the flow tube.

6. The flow meter as claimed in claim 5 wherein a second pair of cavities is formed in the interior surface of the bottom wall, the second pair of cavities being in direct vertical alignment with the first pair of cavities.

7. The flow meter as claimed in claim 3 wherein the set of reflectors additionally comprises a pair of lower reflectors mounted in the bottom wall of flow tube in direct vertical alignment with the set of transducers.

8. The flow meter as claimed in claim 7 wherein each of the pair of lower reflectors is disposed beneath the interior surface of the flow tube.

9. The flow meter as claimed in claim 8 wherein the set of reflectors together redirects a sound wave transmitted from one of the set of transducers to the other of the set of transducers along a W-shaped travel path.

10. The flow meter as claimed in claim 3 wherein the hollow flow tube comprises a left-side piece and a right-side piece that are coupled together.

11. The flow meter as claimed in claim 10 wherein the left-side piece and the right-side piece are coupled together using complementary sets of press-fit posts and bores.

12. The flow meter as claimed in claim 3 further comprising a temperature sensor mounted in the flow tube in fluid communication with the internal passageway.

13. The flow meter as claimed in claim 12 wherein the temperature sensor is mounted in the top wall of the flow tube behind the center reflector.

14. The flow meter as claimed in claim 13 wherein the temperature sensor is mounted in the flow tube in a spaced apart relationship relative to the center reflector so as to define a narrow fluid channel therebetween.

15. The flow meter as claimed in claim 14 wherein the center reflector is mounted in the top wall of the flow tube through a non-watertight relationship.

16. The flow meter as claimed in claim 15 further comprising a flow cell coaxially mounted over the flow tube so as to substantially enclose the temperature sensor.

17. The flow meter as claimed in claim 16 wherein a sealant is disposed between the temperature sensor and the flow cell to create a watertight seal therebetween.
